(19) United States
(12) Patent Application Publication
(10) Pub. No.: US 2013/0093679 A1
(43) Pub. Date: Apr. 18, 2013

(54) User Interface with Localized Haptic Response

(71) Applicants: Timothy Dickinson, Crystal Lake, IL (US); Rachid M. Alameh, Crystal Lake, IL (US); Jeong J. Ma, Long Grove, IL (US); Kenneth A. Paitl, West Dundee, IL (US); Jiri Slaby, Buffalo Grove, IL (US)

(72) Inventors: Timothy Dickinson, Crystal Lake, IL (US); Rachid M. Alameh, Crystal Lake, IL (US); Jeong J. Ma, Long Grove, IL (US); Kenneth A. Paitl, West Dundee, IL (US); Jiri Slaby, Buffalo Grove, IL (US)

(73) Assignee: Motorola Mobility, Inc., Libertyville, IL (US)

(21) Appl. No.: 13/274,417

(22) Filed: Oct. 17, 2011

(51) Int. Cl. G06F 3/02

(52) U.S. Cl. 345/168

(57) ABSTRACT

An interface peripheral (101) for delivering haptic feedback includes a plurality of user input elements (107, 108, 109, 110, 111, 112) that can be configured as keys. An engagement layer (222) or mechanical sheet spans two or more of the keys. One or more motion generation components (228, 229) can be coupled to the engagement layer. When a user actuates a key, it translates to close a switch, which can be a membrane switch or force sensing resistive switch. A control module (2105) actuates a motion generation component and the engagement layer (222) engages the actuated key or keys via either compression engagement or translation engagement. A haptic response (617) is delivered to the engaged key via the engagement layer.

### BACKGROUND

1. Technical Field

This invention relates generally to user interface peripherals, and more particularly to a user interface configured to deliver a haptic response to a user input element.

2. Background Art

Compact portable electronic devices are becoming increasingly popular. As more and more users carry these electronic devices, manufacturers are designing smaller devices with increased functionality. By way of example, not too long ago a mobile telephone was a relatively large device; its only function was that of making telephone calls. Today, however, mobile telephones fit easily in a shirt pocket and often include numerous “non-phone” features such as cameras, video recorders, games, web browsers, and music players.

Just as the feature set included with compact portable electronic devices has become more sophisticated, so too has the hardware itself. Most portable electronic devices of the past included only manually operated buttons. Today, however, manufacturers are building devices with “touch sensitive” screens and user interfaces that include no physical buttons or keys. Instead of pressing a button, the user touches “virtual buttons” presented on the display to interact with the device.

Despite the convenience and flexibility of these devices, many users today still prefer the familiarity of a more classic user interface. Some find the small touch screen user interfaces cumbersome to operate and prefer, for example, a full size QWERTY keyboard. While some electronic devices allow a conventional keyboard to be coupled as a user interface, prior art keyboard technology results in large form-factor designs. Users generally do not want to carry large keyboards along with their compact electronic device. As a result, such keyboards are relegated to limited usage. It would be advantageous to have an improved user input device.

### BRIEF DESCRIPTION OF THE DRAWINGS

FIG. 1 illustrates one interface peripheral in operation with an electronic device in accordance with one or more embodiments of the invention.

FIG. 2 illustrates an exploded view of one explanatory interface peripheral configured in accordance with one or more embodiments of the invention.

FIG. 3 illustrates a sectional view of one explanatory interface peripheral configured in accordance with one or more embodiments of the invention.

FIG. 4 illustrates a sectional view of another explanatory interface peripheral configured in accordance with one or more embodiments of the invention.

FIG. 5 illustrates a sectional view of yet another explanatory interface peripheral configured in accordance with one or more embodiments of the invention.

FIG. 6 illustrates one explanatory haptic user interface system, operable with an electronic device, functioning to deliver a haptic response in accordance with one or more embodiments of the invention.

FIG. 7 illustrates another explanatory haptic user interface system, operable with an electronic device, functioning to deliver a haptic response in accordance with one or more embodiments of the invention.

FIG. 8 illustrates an exploded view of another explanatory interface peripheral configured in accordance with one or more embodiments of the invention.

FIG. 9 illustrates an exploded view of yet another explanatory interface peripheral configured in accordance with one or more embodiments of the invention.

FIG. 10 illustrates a haptic user interface system configured with a force sensor in accordance with one or more embodiments of the invention.

FIG. 11 illustrates an explanatory coupling of a motion generation component to an engagement layer configured in accordance with one or more embodiments of the invention.

FIG. 12 illustrates another explanatory coupling of a motion generation component to an engagement layer configured in accordance with one or more embodiments of the invention.

FIG. 13 illustrates a haptic user interface system operating with an electronic device in an open folio configuration to deliver haptic feedback in accordance with one or more embodiments of the invention.

FIG. 14 illustrates a haptic user interface system operating with an electronic device in a closed folio configuration to deliver haptic feedback in accordance with one or more embodiments of the invention.

FIG. 15 illustrates an explanatory user input element configured in accordance with one or more embodiments of the invention.

FIG. 16 illustrates different user input elements configured in accordance with one or more embodiments of the invention.

FIG. 17 illustrates different boss and component interaction surfaces that can be used with keys or other user input elements in accordance with one or more embodiments of the invention.

FIG. 18 illustrates a multi-boss user input element configured in accordance with one or more embodiments of the invention.

FIG. 19 illustrates several explanatory boss and component interaction surfaces that can be used with keys or other user input elements in accordance with one or more embodiments of the invention.

FIG. 20 illustrates different configurations of interface peripherals, each being configured in accordance with one or more embodiments of the invention.

FIG. 21 illustrates a schematic block diagram of one interface peripheral configured in accordance with embodiments of the invention.

FIG. 22 illustrates one explanatory method of delivering haptic feedback in accordance with one or more embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF EMBODIMENTS OF THE INVENTION

Various embodiments describe and illustrate a compact user interface, suitable for use with an electronic device, which provides a “legacy” feel. Embodiments include an electromechanical user interface design that delivers the tactile feedback of a conventional keypad or keyboard with a form factor suitable for use with modern, compact, electronic devices. In short, embodiments described below provide a conventional user interface experience with an interface peripheral that is very thin, simple, and compact.

In one or more embodiments, a user interface element configured as a key is disposed above an engagement layer that spans two or more keys and that can selectively engage a single key. The user interface elements can be supported on a common carrier, which may be a thin, flexible sheet.

The engagement layer can define a plurality of apertures, with each aperture corresponding to a boss extending distally away from the user interface element. If the user interface has a single boss, for example, the engagement layer may have a single aperture corresponding to the user interface element. Where the user interface element has multiple bosses, multiple apertures of the engagement layer can correspond to the user interface element. As will be shown and described below, the boss and aperture can have similar or different shapes. In one embodiment, the boss has a round cross section while the aperture is a different shape, e.g., a rectangle.

A membrane switch can be disposed beneath the user interface element opposite the engagement layer. Separators or spacers can separate layers of the membrane switch beneath the engagement layer. The separators or spacers, which may be single devices, or multiple stacked devices, can be configured to allow a user to rest his or her fingers on the user interface elements without those user interface elements traveling along the z-axis (up and down a distance sufficient to close a switch). When a user actuates the user interface element by pressing upon it to deliver a sufficient magnitude of user input force, the membrane switch closes. A control module detects the switch closing. As the user presses the user interface element, the boss can pass through its corresponding aperture to contact a substrate. The boss can then expand to grasp or “engage” the engagement layer. Prior to or during engagement, the control module can fire a motion generation component coupled to the engagement layer to deliver a haptic response through the engagement layer to the pressed user interface element. Note that even though the engagement layer spans multiple user interface elements, haptic response is only delivered to those user interface elements that are actuated by the user. Accordingly, a “localized” haptic response is delivered only to actuated user interface elements and not those unactuated elements spanned by the engagement layer. In this fashion, the user interface peripheral can be made thirty to sixty percent thinner than conventional keyboards. While the interface peripherals described below can deliver a tactile response to only a single key, multi-key tactile feedback can be delivered as well. For example, when the user presses multiple keys, e.g., CTRL+ALT+DEL, the haptic feedback can be delivered to the three actuated keys simultaneously.

User interface peripherals illustrated and described below can work in reverse as well. As will be shown, when the interface is integrated into a folio configuration, for example, a user may actuate the rear side of the user interface element to receive the haptic feedback as well. Said differently, if the interface peripheral is configured as a keypad in a folio, the user can close the folio and press the back layer to actuate one of the user interface elements. Other features can be included as well. For instance, in one or more embodiments the user interface elements also include light pipes that conduct light to provide a backlit user input interface experience. Thus, single user interface elements can be illuminated when they are pressed by a user.

In one or more embodiments, the interface is configured as a keypad that can use mechanical pressure, force sensing devices, resistive touch, and multi-touch technology to deliver haptic responses to the user. The keypad can be made of a thin pliable material, such as a rubber, silicone, or polymer materials. The component interaction surfaces can take a variety of shapes, including semi-spherical, triangular, rectangular, and so forth. When keys are pressed, the component interaction surface forms a variable area contact point. When used with a force sensor, such as a force sensitive resistor, the variable area can be used to determine force. In one or more embodiments, the tactile response delivered to the key can be partially dependent upon the detected force. Although the user interfaces shown are described as separate peripheral devices, the user interfaces could be easily modified to be integrated into the main electronic device. Other form factors are also available, such as accessories for the main electronic device

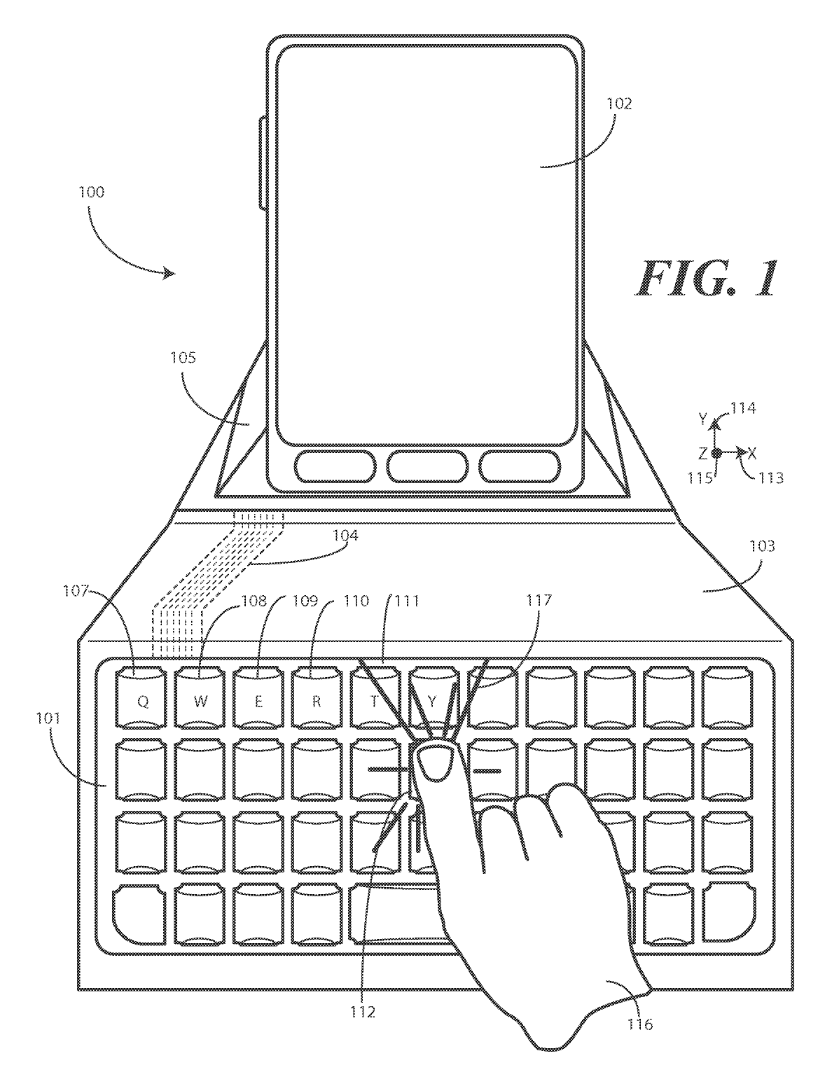

FIG. 1 illustrates a haptic user interface system 100 that includes an interface peripheral 101 configured in accordance with one or more embodiments of the invention operating in tandem with an electronic device 102. The electronic device 102 can be any of a variety of devices, including mobile telephones, smart phones, palm-top computers, tablet computers, gaming devices, multimedia devices, and the like.

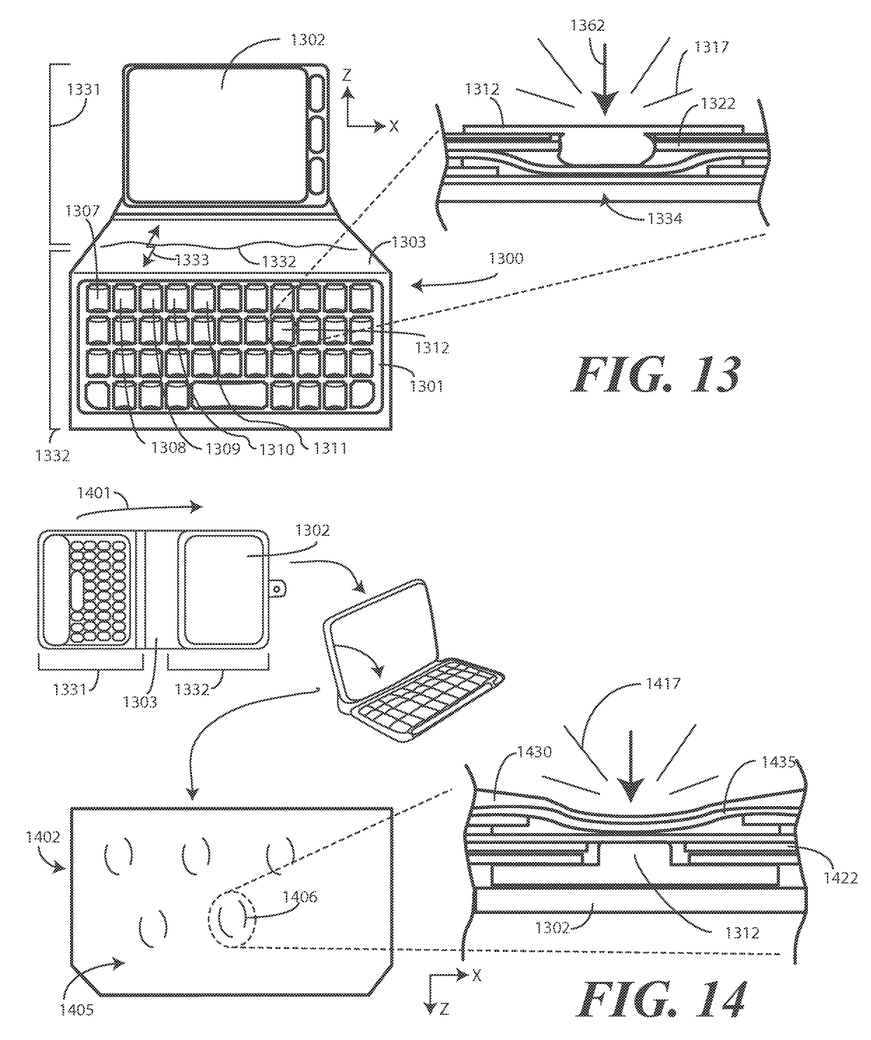

The explanatory haptic user interface system 100 of FIG. 1 is arranged in a folio configuration, with a folio 103 serving as a housing for both the interface peripheral 101 and the electronic device 102. Folio configurations will be described in more detail below with reference to FIGS. 13-14. A folio configuration is but one configuration suitable for interface peripherals 101 configured in accordance with embodiments of the invention, as others will be readily apparent to those of ordinary skill in the art having the benefit of this disclosure as well. Illustrating by example, the interface peripheral 101 could be configured as a stand-alone device that communicates with the electronic device 102 via wireless communcation.

A bus 104 conveys electronic signals between the electronic device 102 and the interface peripheral 101 in this illustration. It will be clear to those of ordinary skill in the art having the benefit of this disclosure that the interface peripheral 101 and electronic device can be configured to exchange electronic signals in any of a variety of ways, including via wire, bus, wireless communications such as Bluetooth, Bluetooth Low Energy (BTLE), Wi-Fi, or other wireless communications, optical communication (including infrared), and so forth.

The folio configuration shown in FIG. 1 includes a dock 105 configured to couple with the electronic device 102 and a retention member that retains the interface peripheral 101 within the folio 103. The folio configuration is convenient because a user can simply unfold the folio 103 to use the interface peripheral 101 and electronic device 102. Folding the folio 103 results in both devices being contained within the outer folio layer, thus protecting the interface peripheral 101 and electronic device 102 from outside debris. Just as the electronic device 102 is detachable from the dock 105, the interface peripheral 101 can be selectively removed from the folio 103.

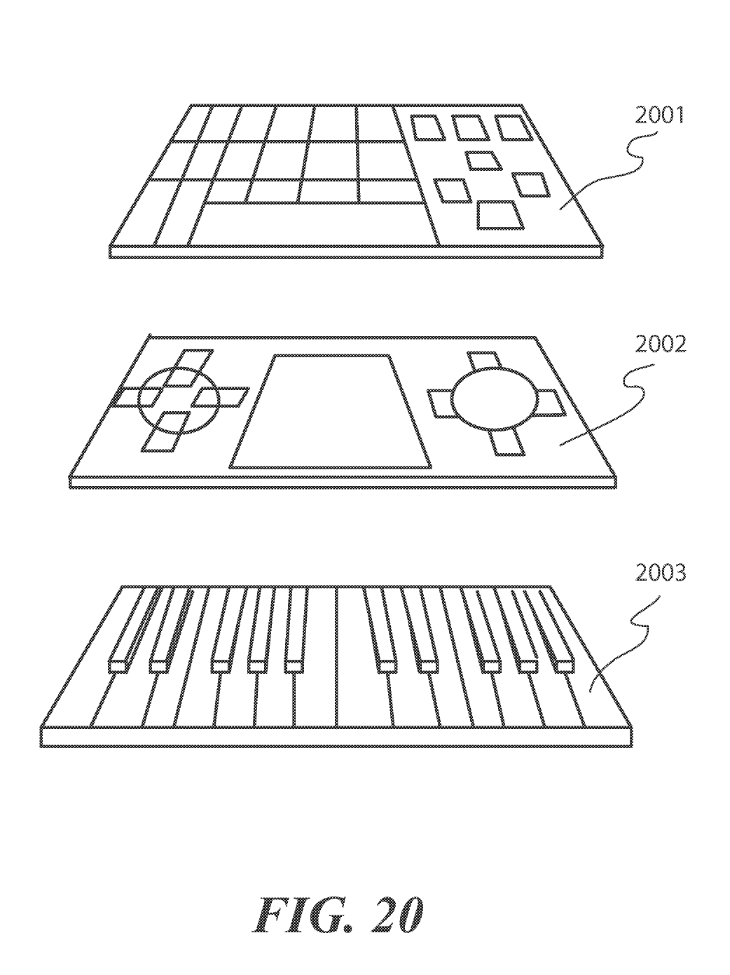

A plurality of user input elements, e.g., user input elements 107, 108, 109, 110, 111, 112 are disposed along a major face of the interface peripheral 101. Each user input element 107, 108, 109, 110, 111, 112 is moveable along a first axis to close a switch. In this illustrative embodiment, the interface peripheral 101 is configured as a QWERTY keypad, with each user input element 107, 108, 109, 110, 111, 112 being configured as a key. Other configurations, including a musical keyboard, gaming keyboard, or learning keyboard, will be described below with reference to FIG. 20. Using a three-coordinate system to describe orientation of components with reference to three-dimensional space, the z-axis 115 serves as the first axis, with the x-axis 113 and y-axis 114 serving as reference designators for a second axis and third axis, respectively.

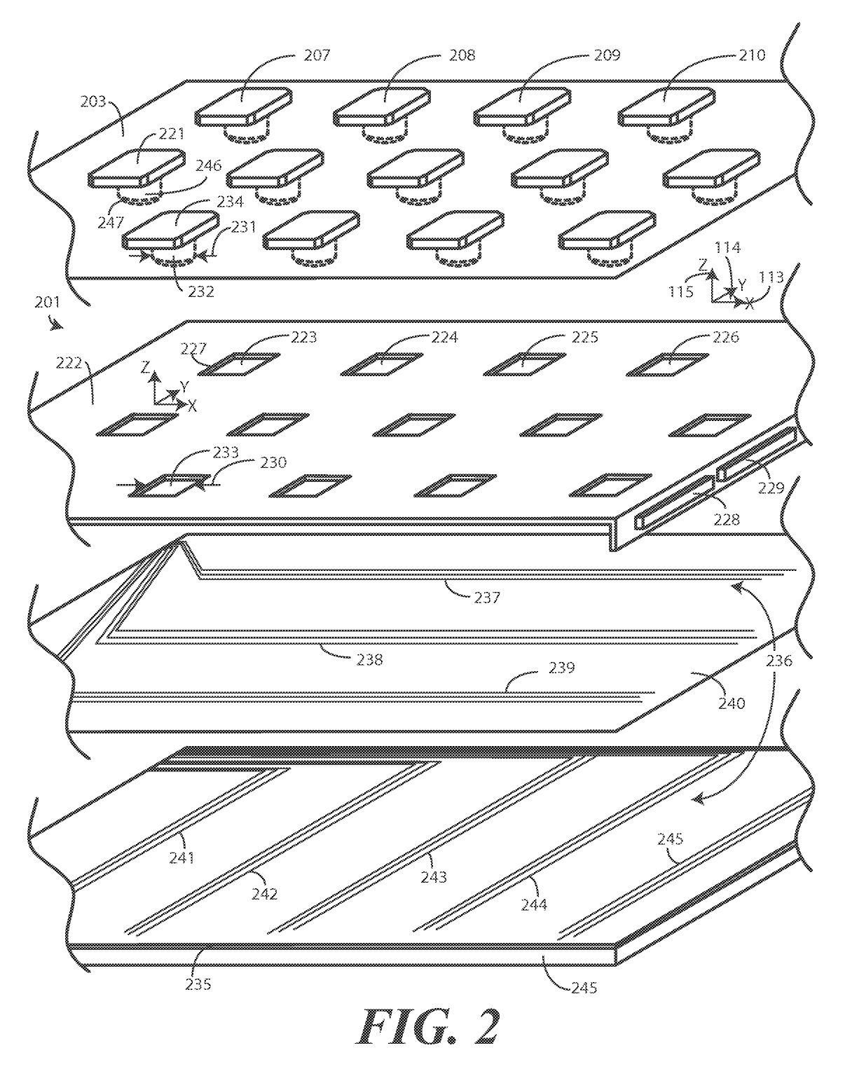

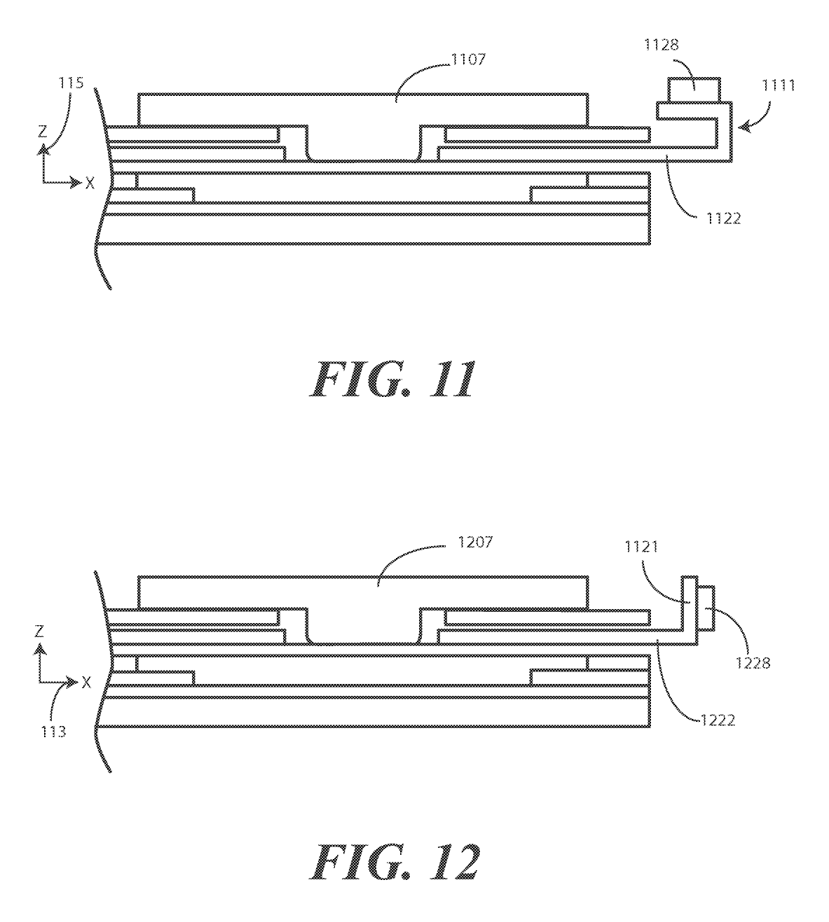

A user 116 actuates one or more of the user input elements 107, 108, 109, 110, 111, 112 by moving a user input element 112 along the first axis. Sufficient movement of the user input element 112 along the first axis closes a switch disposed beneath the user input element 112. Disposed between the user input element 112 and the switch is a mechanical layer that spans a plurality of the user input elements 107, 108, 109, 110, 111, 112 along the second and third axes. Examples of mechanical layers will be described in more detail with reference to FIGS. 2, 8, and 9. One or more haptic devices, which are operable with and coupled to the mechanical layer, are configured to impart a force upon the mechanical layer upon being fired by a control module of the interface peripheral 101. Coupling of haptic devices to the mechanical layer will be described in more detail below with reference to FIGS. 11 and 12.

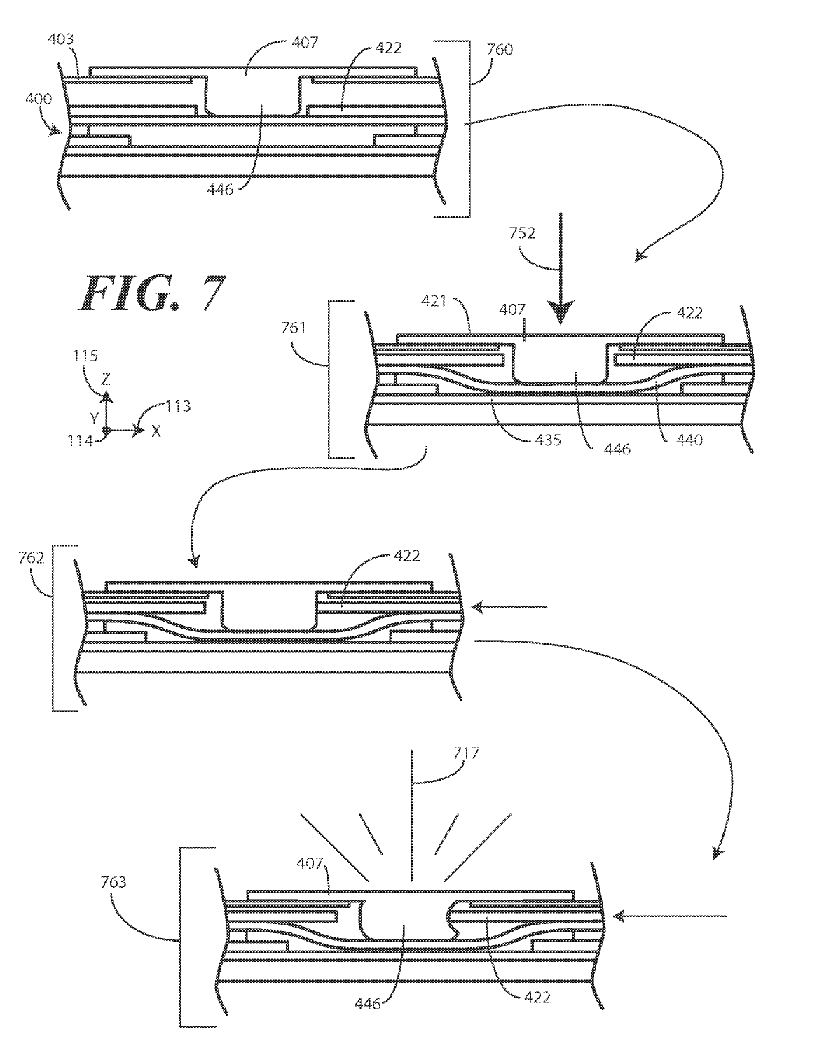

When the user 116 actuates the user input element 112 and the switch closes, in one embodiment a boss extending from the user input element 112 is configured to expand in response to the application of force to engage the mechanical layer. The control module actuates a haptic device coupled to the mechanical layer to deliver a haptic response 117 to the user input element 112. In one embodiment, the haptic response 117 is delivered to the user input element 112 when engaged with the mechanical layer. This embodiment will be described in more detail below with reference to FIG. 6. In another embodiment, apertures of the mechanical layer are coordinated with motion along the second and third axes to deliver the haptic response 117 to the user input element 112 without the user input element 112 previously engaging the mechanical layer. This embodiment will be described in more detail with reference to FIG. 7.

FIG. 2 illustrates an exploded view of one explanatory interface peripheral 201 configured in accordance with one or more embodiments of the invention. Beginning from the top of FIG. 2, a plurality of user input elements 207, 208, 209, 210 are configured as physical keys. The user input elements 207, 208, 209, 210 are disposed along a key carrier 203. The key carrier 203 may be a thin layer of film to which the user input elements 207, 208, 209, 210 are coupled.

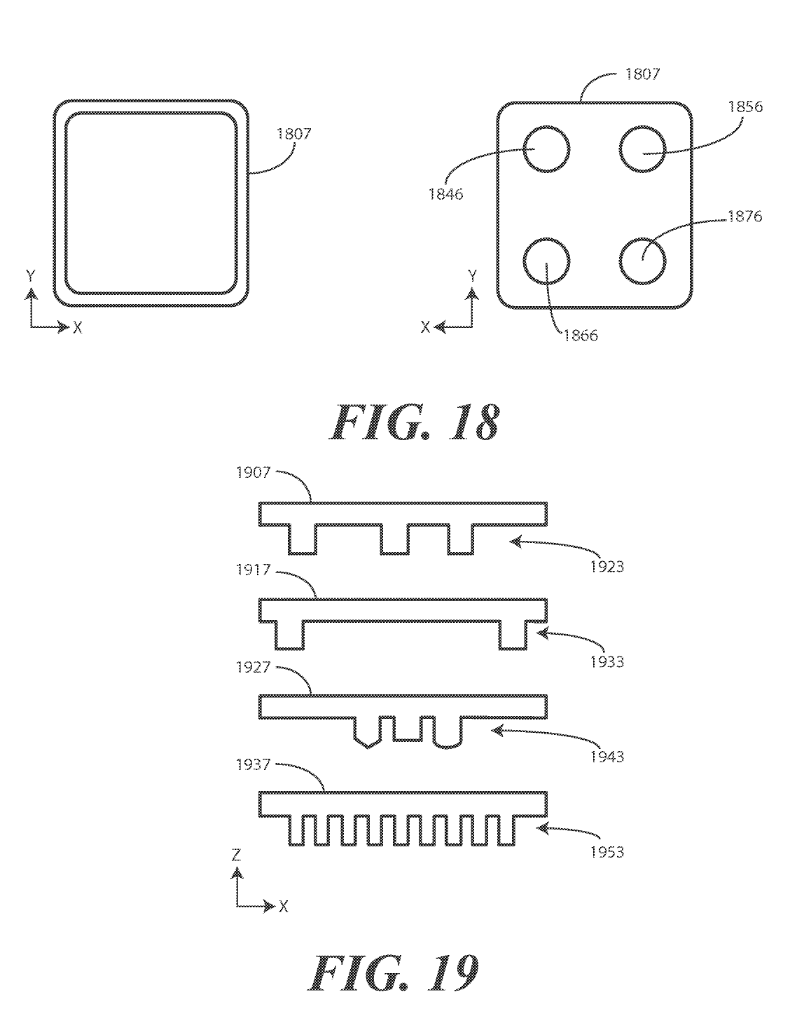

Each user input element 207, 208, 209, 210 includes a user interaction surface 221 with which a user may press or otherwise actuate the user input element 207, 208, 209, 210. Each user input element 207, 208, 209, 210 in this explanatory embodiment also includes a boss 246 extending distally away from the user interaction surface 221. While each user input element 207, 208, 209, 210 of FIG. 2 is shown with a single boss 246, multiple bosses can be used with each user input element 207, 208, 209, 210 as will be described with reference to FIGS. 18 and 19 below.

Each boss 246 terminates in a component interaction surface 247. The explanatory component interaction surfaces 247 of FIG. 2 are shown as being semi-spherical. However, other contours and shapes can be used as well, some of which will be described below with reference to FIG. 17.

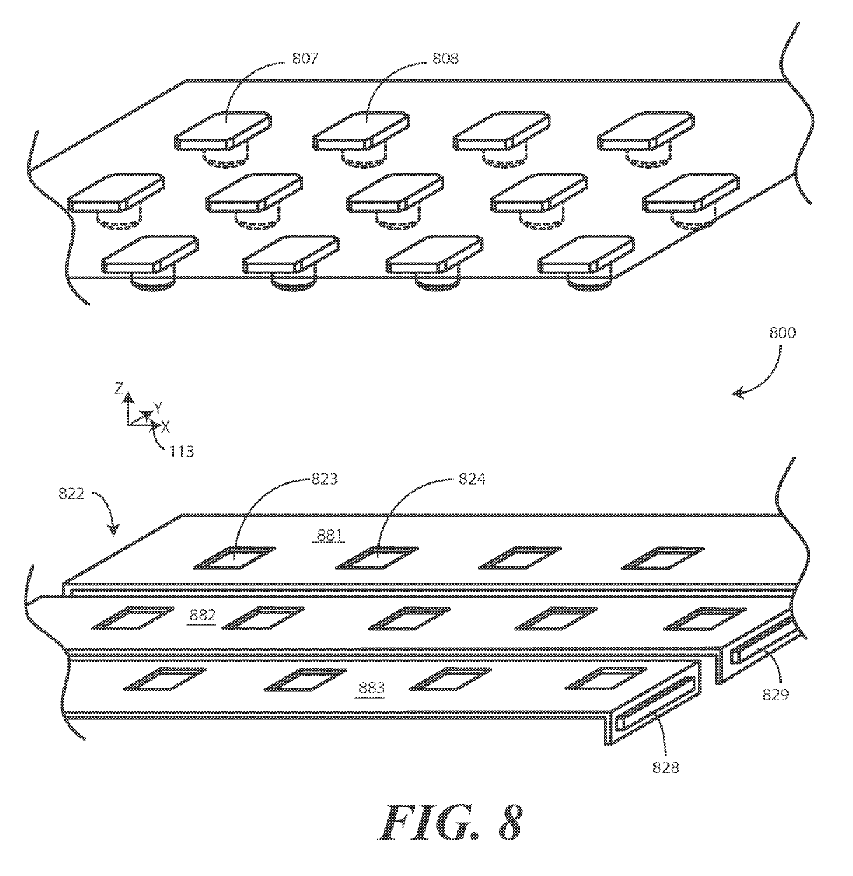

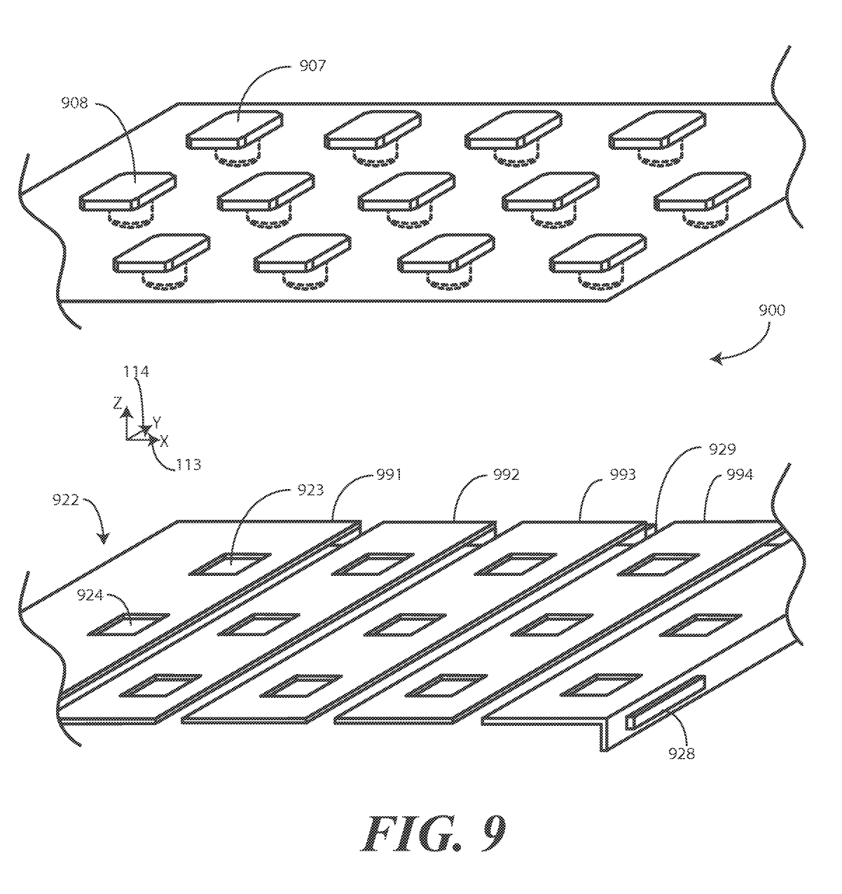

Disposed beneath the user input elements 207, 208, 209, 210 is an engagement layer 222. The engagement layer 222 can be configured as a thin metal layer or thin plastic layer, and forms a mechanical layer that spans two or more of the user input elements 207, 208, 209, 210. As will be explained in more detail below, the engagement layer 222 can comprise a lightguide. In the explanatory embodiment of FIG. 2, the engagement layer spans all user input elements 207, 208, 209, 210. However, other configurations where the engagement layer 222 spans only subsets of user input elements can also be used, as will be described below with reference to FIGS. 8 and 9.

The engagement layer 222 defines a plurality of apertures 223, 224, 225, 226 that correspond to the user input elements 207, 208, 209, 210. In one embodiment, the engagement layer 222 is a conduit for light projected by light sources of the interface peripheral 201, and accordingly can function as a light guide to backlight or otherwise illuminate the interface peripheral 201. Since only one boss 246 extends from each user input element 207, 208, 209, 210, the apertures 223, 224, 225, 226 shown in FIG. 2 correspond to the user input elements 207, 208, 209, 210 on a one-to-one basis. Where multiple bosses extend from a user input element, multiple apertures can correspond to a single user input element.

The shape of the boss 246 and shape of the apertures 223, 224, 225, 226 can correspond to each other or can be different. For example, in one embodiment, a perimeter 227 of an aperture 223 can be the same shape as the cross section of the boss 246. The perimeter 227 can be circular when the cross section of the boss 246 is circular. In another embodiment, the perimeter 227 of an aperture 223 can be similar to, but different from, the cross section of the boss 246. For instance, if the cross section of the boss 246 is circular, the perimeter 227 of the aperture 223 can be oval. In yet another embodiment, the perimeter 227 of the aperture 223 can be different than the cross section of the boss 246. In FIG. 2, the perimeter 227 of the aperture is rectangular in shape while the boss 246 has a round cross section.

In one or more embodiments, a width 230 of each aperture 223, 224, 225, 226 is greater than a diameter 231 of the boss 232 to which it corresponds. This configuration allows the boss 232 to initially pass through the corresponding aperture 233 when the user moves the corresponding user input element 234 along the z-axis 115 (in the negative direction).

One or more motion generation components 228, 229 can be coupled to the engagement layer 222. In one embodiment, the motion generation components 228, 229 are piezoelectric devices. Other devices can also be used, including vibrator motors, rotator motors, an artificial muscle, electrostatic plates, or combinations thereof. While piezoelectric transducers are but one type of motion generation component suitable for use with embodiments of the present invention, they are well suited to embodiments of the present invention in that they provide a relatively fast response and a relatively short resonant frequency. Prior art haptic feedback systems have attempted to mount such devices directly to the device housing or the user interface surface. Such configurations are problematic, however, in that piezoelectric materials can tend to be weak or brittle when subjected to impact forces. Consequently, when such a prior art configuration is dropped, these “directly coupled” configurations can tend to break or malfunction. Embodiments of the present invention avoid such maladies in that the piezoelectric devices are coupled to the engagement layer 222, which is suspended within the interface peripheral 201. The piezoelectric devices are able to vibrate independent of an outer housing. This configuration is better able to withstand common drop testing experiments.

As will be described below with reference to FIGS. 6 and 7, in one or more embodiments the engagement layer 222 is configured to mechanically engage at least one user input element when a user actuates the user input element along the z-axis 115. For instance, when a single key is actuated, the engagement layer 222 will engage the single key only, even though the engagement layer 222 spans multiple keys along the x-axis 113 and y-axis 114. However, if multiple keys are actuated along the z-axis 115, the engagement layer 222 will engage only the actuated keys, despite the fact that the engagement layer 222 spans both actuated and non-actuated keys along the x-axis 113 and y-axis 114. In short, the engagement layer 222 can be configured to engage keys actuated along the z-axis 115 without engaging non-actuated keys, despite the fact that the engagement layer 222 spans both actuated and non-actuated keys along the x-axis 113 and y-axis 114.

“Engagement” as used with the engagement layer refers to mechanically grasping, clenching, holding, catching, seizing, grabbing, deforming, or latching to the user input element 207, 208, 209, 210. For example, a boss 232 can be configured to contact a lower layer 235 and a rigid substrate 245 when a user moves the corresponding user input element 234 along the z-axis 115 (in the negative direction). Where the boss 232 is manufactured from a pliant material, this contact can cause the diameter 231 of the boss 232 to expand along the x-axis 113 and y-axis 114 after being depressed against the rigid substrate 245. As the diameter 231 expands, the pliant material of the boss 232 “engages” the engagement layer by grasping the sides of the corresponding aperture 233. Said differently, the boss 232 in this embodiment is configured to expand upon actuation to grip a perimeter of its corresponding aperture 233. This is one example of engagement. Others will be described, for example, with reference to FIG. 7. Still others will be obvious to those having ordinary skill in the art and the benefit of this disclosure.

In one embodiment, when the engagement layer 222 is engaged with an actuated user input element, the engagement layer 222 delivers a haptic response to an actuated user input element when the motion generation component 228, 229 actuates. This occurs as follows: actuation of the motion generation component 228, 229 causes movement of the engagement layer 222 along the x-axis 113, the y-axis 114, or combinations thereof. When engaged with an actuated user input element 234 that has been moved along the z-axis 115 such that its boss 232 has engaged with a corresponding aperture 233, a haptic response will be delivered to the engaged user input element 234.

A lower layer 235 is disposed on a side opposite the engagement layer 222 from the user input elements 207, 208, 209, 210. The lower layer 235 may be combined with a substrate 245 that serves as a base of the interface peripheral 201. The substrate 245 can be rigid. For example, the substrate 245 can be manufactured from FR4 printed wiring board material that can also function as a structural element. The lower layer 235 can be configured as a flexible material or as part of the substrate 245.

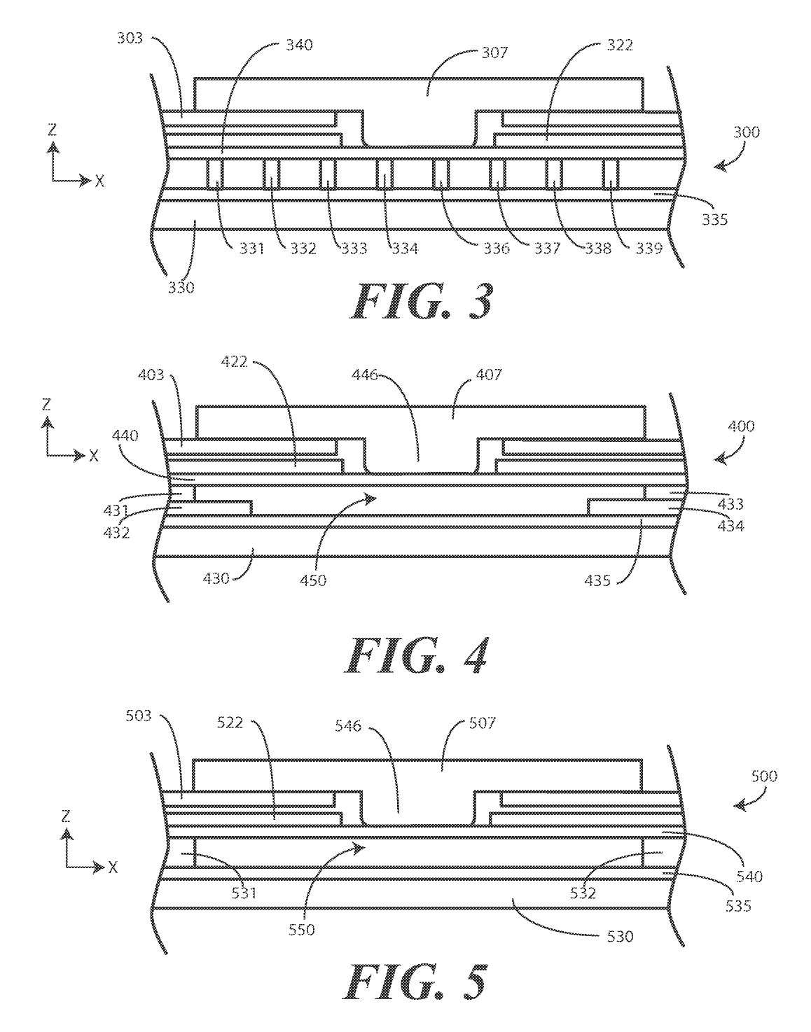

Disposed between the lower layer 235 and the engagement layer 222 is an array 236 of switches. In this explanatory embodiment, the switches of the array 236 are each membrane switches. Membrane switches, which are known in the art, are electrical switches capable of being turned on or off. The membrane switches of FIG. 2 include first conductors 237, 238, 239 that are disposed on a flexible layer 240. The flexible layer 240 can be manufactured from, for example, polyethylene terepthalate (PET), or another flexible substrate material. Second conductors 241, 242, 243, 244, 245 are then disposed on the lower layer 235. Various types of spacer layers can be implemented between flexible layer 240 and lower layer 235, as will be described below with reference to FIGS. 3-5.

When a boss, e.g., boss 232, passes through a corresponding aperture 233 of the engagement layer 222 along the z-axis 115, it contacts one of the first conductors 237, 238, 239 and deforms the flexible layer 240. As the boss 232 continues to move along the z-axis 115, the first conductor 239 engaged by the boss 232 contacts one of the second conductors 241, 242, 243, 244, 245. When this occurs, one switch of the array 236 closes and user input is detected.

When this user input is detected, a control module can actuate or fire one or more of the motion generation components 228, 229. In one embodiment, a delay between closing of the switch and firing of the motion generation component can be inserted. For example, in an embodiment where engagement of the boss 232 with a corresponding aperture 233 occurs when the boss 232 expands along the x-axis 113, y-axis 114, or both, the delay may be inserted to ensure enough time passes for engagement to occur.

FIG. 3 illustrates a sectional view of an interface peripheral 300 configured in accordance with one embodiment of the invention employing a resistive touch panel. As with FIG. 2, the interface peripheral 300 of FIG. 3 includes elements with common dispositions and functions as were described above with reference to FIG. 1. For example, FIG. 3 includes a user input element 307, a key carrier 303, and an engagement layer 322. A substrate 330 of the user interface peripheral forms the base of the interface peripheral 300. The substrate 330 can be flexible or rigid.

As shown in FIG. 3, a series of compressible spacers 331, 332, 333, 334, 336, 337, 338, 339 disposed between a first conductive layer 340 and a second conductive layer 335. Note that the conductive layers 335, 340 can be disposed on electrode film in one or more embodiments. The compressible spacers 331, 332, 333, 334, 336, 337, 338, 339 can be manufactured individually, or alternatively can be cut from a single compressible spacer layer. In certain parlance, the compressible spacers 331, 332, 333, 334, 336, 337, 338, 339 can be referred to as “microspacers.”

Each of the first conductive layer 340 and the second conductive layer 335 has a resistance such that current passing through one or both of the first conductive layer 340 and the second conductive layer 335 can be varied by the amount of contact between the first conductive layer 340 and the second conductive layer 335. When a user applies force to user input element 307, the compressible spacers 331, 332, 333, 334, 336, 337, 338, 339 compress. When enough compression occurs, the first conductive layer 340 and second conductive layer 335 come into contact, thereby closing a switch and allowing a current to flow in accordance with a resistance established by the contact surface area between the first conductive layer 340 and the second conductive layer 335. In addition to triggering a motion generation component upon the closing of the switch, the amount of current flowing can be detected to determine a magnitude of force being applied to the user input element 307.

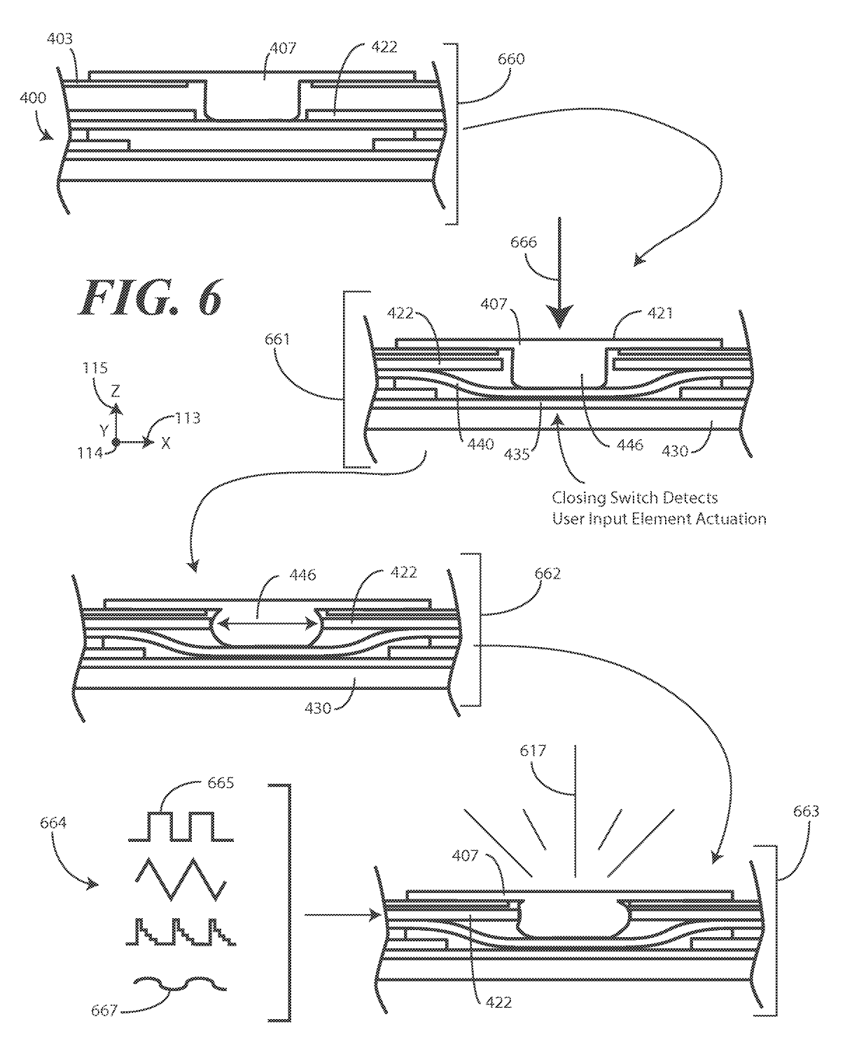

FIGS. 4-5 illustrate two different sectional views of different interface peripherals 400, 500 configured in accordance with embodiments of the invention employing membrane switches. FIGS. 4-5 each include elements with common dispositions and functions as were described above with reference to FIG. 1. For example, each figure includes a user input element 407, 507, a key carrier 403, 503, and an engagement layer 422, 522. Similarly, each figure employs a membrane switch formed by an upper flexible layer 440, 540 and a lower layer 435, 535. A substrate 430, 530 of each interface peripheral 400, 500 forms the base thereof and bounds the lower layer 435, 535 and may provide structural support. The lower layer 435, 535 and the substrate 430, 530 can be formed as a single elements, such as a printed circuit board or FR4 printed wiring board material. Accordingly, the lower layer 435, 535 and the substrate 430, 530 can be each be either flexible or rigid.

Differences between FIGS. 4-5 occur in the support arrangement disposed between the membrane switches. FIG. 4 uses pairs of stacked spacers 431, 432, 433, 434. For example, stacked spacers 431-433 form a first spacer pair, while stacked spacers 432, 434 form a second spacer pair. FIG. 5 employs single spacers 531, 532 between the upper flexible layer 540 and the substrate 530. In FIGS. 4-5, the stacked spacers 431, 432, 433, 434 or single spacers 531, 532 can be formed from a unitary element, or can be independent elements.

In FIGS. 4 and 5, the stacked spacers 431, 432, 433, 434 or single spacers 531, 532 can be arranged to define apertures 450, 550 through which the boss 446, 546 may pass. Accordingly, as with the engagement layer 422, 522 the apertures 450, 550 can have shapes that correspond to the boss 446, 546 or are different from the boss 446, 546. For example, in one embodiment, a perimeter of the apertures 450, 550 can be the same shape as the cross section of the boss 446, 546. The perimeter can be circular when the cross section of the boss 446, 546 is circular. In another embodiment, the perimeter of the apertures 450, 550 can be similar to, but different from, the cross section of the boss 446, 546. For instance, if the cross section of the boss 446, 546 is circular, the perimeter of the apertures 450, 550 can be oval. In yet another embodiment, the perimeter of the apertures 450, 550 can be different than the cross section of the boss 446, 546.

In one illustrative embodiment using stacked spacers 431, 432, 433, 434, the stacked spacers 431, 432, 433, 434 can define different aperture shapes. For example, stacked spacers 431, 433 can define a square aperture, while stacked spacers 433, 434 define a round aperture, or vice versa. In other embodiments, each of the stacked spacers 431, 432, 433, 434 can define apertures with a common shape. For example, the perimeter of the defined apertures 450 can be the same shape as the boss 446. Where single spacers 531, 532 are used, the perimeter of the apertures 550 can be rectangular in shape, while the boss 546 has a round cross section. Testing has shown a configuration usig stacked spacers 431, 432, 433, 434 with stacked spacers 431, 433 defining a square aperture and stacked spacers 433, 434 defining a round aperture to allow a user to rest fingers on the user input elements without closing the membrane switch.

FIG. 6 illustrates a method of delivering a haptic response 617 to a user input element 407 in accordance with one or more embodiments of the invention. FIG. 6 employs the interface peripheral 400 of FIG. 4 for explanatory purposes.

At step 660, the interface peripheral 400 is in a non-actuated state. The user input element 407 rests on the key carrier 403. At step 661, a force 666 is applied to the user interaction surface 421 of the user input element 407. The force 666 translates the user input element 407 along the z-axis 115 (in the negative direction). This translation moves the boss 446 through the engagement layer 422. The translation also closes the membrane switch by pressing flexible layer 440 against lower layer 435, thereby causing the contacts on each to electrically connect.

At step 662, the continued pressure upon the user input element 407 along the z-axis 115 when opposed by the substrate 430 causes the boss 446 to expand, thereby engaging the engagement layer 422 by expanding and gripping the perimeter of the aperture of the engagement layer 422. This is known as “compression engagement.”

At step 663, a control module, triggered by the membrane switch closing at step 661, fires a haptic element coupled to the engagement layer 422. This causes the engagement layer 422 to move along an axis substantially orthogonal with the z-axis 115 to deliver the haptic response 617 to the user input element 407. For instance, where a first haptic device coupled to the engagement layer 422 is oriented to impart a force upon the engagement layer 422 along the x-axis 113 and a second haptic device coupled to the engagement layer 422 oriented to impart another force along the y-axis 114, firing the haptic elements can cause the engagement layer 422 to move along the x-axis 113, the y-axis 114, or combinations thereof.

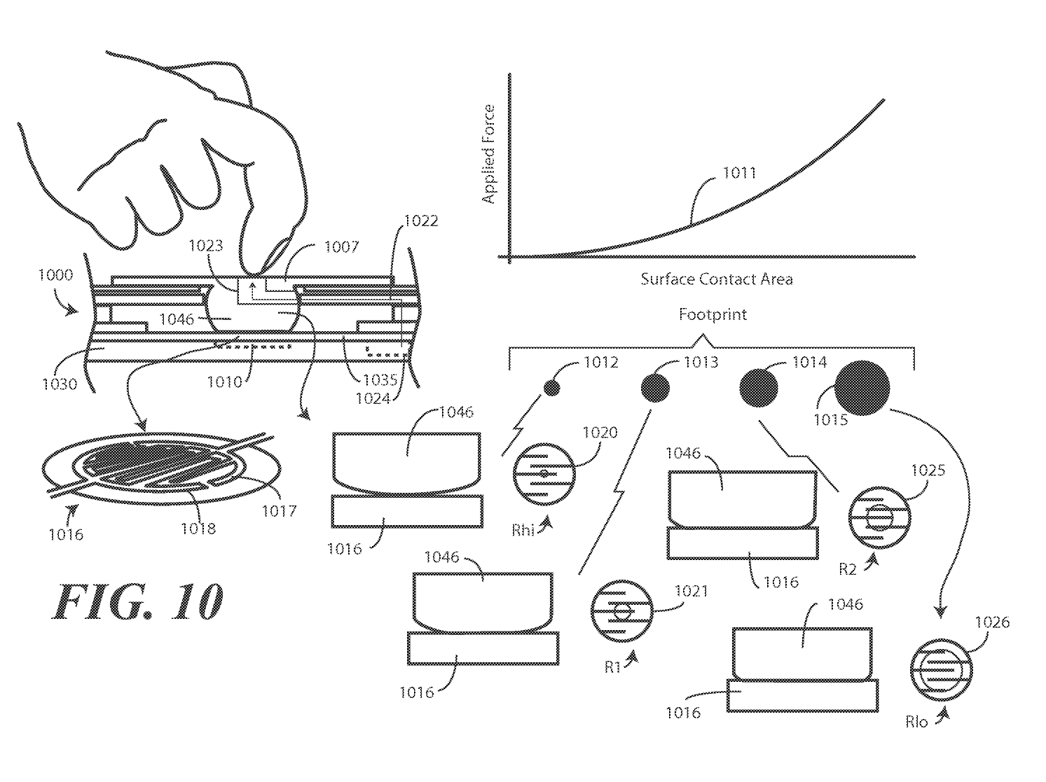

As shown in FIG. 6, the haptic element(s) can be driven with a variety of waveforms 664 to impart haptic responses that are tailored to specific users, active modes of an electronic device to which the interface peripheral 400 is coupled, or to specific keystrokes. For example, as will be described below with reference to FIG. 10, in one or more embodiments, a magnitude of the applied force 666 can be detected. Note that the force magnitude detection of FIG. 10 can also be applied to FIG. 3 as previously described by detecting current through conductive layers. The haptic response 617 can be a function of the detected force. Accordingly, a user who has a forceful keystroke may receive a forceful haptic response via the use of a high-amplitude square wave 665 to drive the haptic element. Conversely, a user with a light touch may receive a soft haptic response via low-amplitude sine wave 667 used to drive the haptic element or a low-amplitude square wave (not shown). In addition to (or in lieu of) changing waveform and/or amplitude dependent upon a detected force 666 of a keypress, frequency and/or phase may be adjusted.

It should be noted that steps 662 and 663 could occur in either order. In one embodiment, the haptic element will be fired before the boss 446 engages the engagement layer 422. Said differently, step 663 will occur before step 662. In another embodiment, the boss 446 will engage the engagement layer 422 prior to the haptic device firing. In other words, step 662 will occur before step 663. One way to ensure the latter embodiment occurs is to insert a delay between the closing of the switch occurring at step 661 and the firing of the haptic element that occurs at step 663.

FIG. 7 illustrates another method of delivering a haptic response 717 to a user input element 407 in accordance with one or more embodiments of the invention. As with FIG. 6, FIG. 7 employs the interface peripheral 400 of FIG. 4 for explanatory purposes. FIG. 7 differs from FIG. 6 in that the engagement of the user input element 407 occurs due to translation of the engagement layer 422 rather than expansion of the boss 446 due to applied force. The embodiment of FIG. 7 allows a satisfying haptic response 717 to be delivered to users having lighter touches than those illustrated in FIG. 6.

At step 760, the interface peripheral 400 is in a non-actuated state. The user input element 407 rests on the key carrier 403. At step 761, a force 752 is applied to the user interaction surface 421 of the user input element 407. The force 752 translates the user input element 407 along the z-axis 115 (in the negative direction). This translation moves the boss 446 through the engagement layer 422. The translation also closes the membrane switch by pressing flexible layer 440 against lower layer 435, thereby causing the contacts on each to electrically connect.

At step 762, a control module fires a haptic element coupled to the engagement layer 422. This causes the engagement layer 422 to move along an axis substantially orthogonal with the z-axis 115. For instance, where a first haptic device coupled to the engagement layer 422 is oriented to impart a force upon the engagement layer 422 along the x-axis 113 and a second haptic device coupled to the engagement layer 422 oriented to impart another force along the y-axis 114, firing the haptic elements can cause the engagement layer 422 to move along the x-axis 113, the y-axis 114, or combinations thereof.

At step 763, the continued translation of the engagement layer 422 along the x-axis 113, y-axis 114, or a combination thereof, causes the engagement layer 422 to engage the user input element 407. This engagement grips at least a portion of the boss 446 against the engagement layer 422 and delivers the haptic response 717 to the user input element 407. This is known as “translation engagement.”

FIGS. 8 and 9 illustrate alternate interface peripherals 800, 900 configured in accordance with embodiments of the invention. In FIGS. 8 and 9, rather than using a single sheet for the engagement layer (222), as was the case in FIG. 1, the engagement layers 822, 922 comprise a plurality of sheets 881, 882, 883, 991, 992, 993, 994. Each sheet spans a plurality of keys. For example, sheet 881 spans both keys 807 and 808. Similarly, sheet 991 spans both keys 907 and 908.

As with the engagement layer (222) of FIG. 2, the engagement layers 822, 922 of FIGS. 8 and 9 can be configured as a thin metal layers or thin plastic layers. Each defines a plurality of apertures 823, 824, 923, 924 that correspond to the keys 807, 808, 907, 908.

One or more motion generation components 828, 829, 928, 929 can be coupled to the engagement layers 822, 922. In FIG. 8, the motion generation components 828, 829 are oriented to impart a force to the engagement layers 822 along the x-axis 113. In FIG. 9, a first motion generation component 928 is oriented to impart a force along the x-axis 113. A second motion generation component 929 is oriented to impart a force along the y-axis 114.

Since multiple sheets 881, 882, 883, 991, 992, 993, 994 are used in FIGS. 8 and 9, the control modules of the interface peripherals 800, 900 may select which sheet 881, 882, 883, 991, 992, 993, 994 to move in response to user input. Accordingly, each control module can be configured to selectively actuate a haptic device to move only the sheet that corresponds to the actuated key. For instance, if key 907 was actuated, the control module could select sheet 991 for movement by firing the haptic device coupled to sheet 991. In other words, where multiple motion generation components 828, 829, 928, 929 are used, the control module can determine which of the sheets 881, 882, 883, 991, 992, 993, 994 corresponds to an actuated key and can activate only the motion generation component coupled to the sheet corresponding to the actuated key.

FIG. 10 illustrates an interface peripheral 1000 employing an array of force sensing resistive switches 1010 disposed with a contact layer 1035 under the engagement layer 1022. In FIG. 10, for ease of illustration, one user input element 1007 is shown with a single force sensing resistive switch 1010 corresponding to the user input element 1007. An interface peripheral having multiple keys would employ an array, with each force sensing resistive switch being associated with a corresponding user input element. Each force sensing resistive switch 1010 is configured to determine a force magnitude 1011 applied to the user input element 1007. In one embodiment, this occurs by detecting an engagement surface area 1012, 1013, 1014, 1015 between a boss 1046 extending from the user input element 1007 and a corresponding force sensing resistive switch 1010. Force sensing can also occur by detecting an amount of current flowing through conductive members of a resistive touch panel as described above with reference to FIG. 3.

A magnified view of one embodiment of a force sensing resistive switch 1010 is shown as an electrode node 1016. This electrode node 1016 can be repeated on the contact layer 1035 to form the array of force sensing resistive switches.

The electrode node 1016 has two conductors 1017, 1018. The conductors 1017, 1018 may be configured as exposed copper or aluminum traces on a printed circuit board or flexible substrate 1030. The two conductors 1017, 1018 are not electrically connected with each other. In one embodiment, the two conductors 1017, 1018 terminate in an interlaced finger configuration where a plurality of fingers from the first conductor 1017 alternate in an interlaced relationship with a plurality of fingers from the second conductor 1018.

The electrode node 1016 can be configured in a variety of ways. For example, in one embodiment the electrode node 1016 can be simply left exposed along a surface of the substrate 1030. In another embodiment the electrode node 1016 can be sealed to prevent dirt and debris from compromising the operative reliability of the electrodes. In another embodiment, a conductive covering can be placed atop the electrode node 1016 to permit the electrode node 1016 to be exposed, yet protected from dirt and debris.

In the explanatory embodiment of FIG. 10, the electrode node 1016 is configured to be circular. It will be clear to those of ordinary skill in the art having the benefit of this disclosure that embodiments of the invention are not so limited. The electrode node 1016 can be configured in any of a number of geometric shapes, sizes, and interlacing configurations.

To function with the electrode node 1016, the boss 1046, its component interaction surface, or both, will be constructed from a conductive material. For example, the boss 1046 can be manufactured from a resilient, pliable material such as an elastomer that is further capable of conducting current. Such conductive elastomers are known in the art. The benefits of conductive elastomers as they relate to embodiments of the present invention are four-fold: First, they are compressible. This allows for varying surface contact areas to be created across the electrode node 1016. Second, conductive elastomers may be designed with resistances that are within acceptably accurate ranges. Third, the conductive elastomers may be doped with various electrically conductive materials to set an associated resistance, or to vary the resistances of each boss 1046. Fourth, conductive elastomers are easily shaped.

Compression of the boss 1046 against the electrode node 1016 forms a resistive path between the first conductor 1017 and the second conductor 1018. Compression of the boss 1046 with different amounts of force results in establishment of different resistances across the electrode node 1016. The boss 1046 effectively gets “squished” against the electrode node 1016 in a degree corresponding to the applied force. This results in more or fewer of the interlaced fingers of the electrode node 1016 coming into contact with the conductive portion of the boss 1046. Where the control module of the interface peripheral 1000 is capable of detecting current flowing through—or voltage across—the electrode node 1016, the control module can detect an electrical equivalent, i.e., voltage or current, corresponding to how “hard” the boss 1046 of the user input element 1007 is pressing against the electrode node 1016. When a user manipulates the user input element 1007, the compressible, conductive material of the boss 1046 can expand and contract against the electrode node 1016, thereby changing the impedance across the electrode node 1016. The control module can detect the resulting change in current or voltage, and then to interpret this as user input.

FIG. 10 includes a graphical representation of illustrative compression amounts, each of which establishes a corresponding resistance across the electrode node 1016 that can be sensed—either as voltage or current—by the control module. As noted above, varying compression can be applied in accordance with the size, elasticity, shape, or height of the boss 1046 or component interaction surface, or with doping.

At contact view 1020, the boss 1046 is just barely touching the electrode node 1016. This initial engagement establishes a high impedance, Rhi, which corresponds to a minimal force being applied to the user input element 1007. At contact view 1021, a greater amount of contact is occurring between the boss 1046 and the electrode node 1016. This establishes a resistance, R1, which is less than Rhi and corresponds to a slightly larger force being applied to user input element 1007 than at contact view 1020.

At contact view 1025, a still greater amount of contact is occurring between the boss 1046 and the electrode node 1016. This establishes a second resistance, R2, with a value that is less than resistance R1, and that corresponds to a greater amount of force being applied to the user input element. At contact view 1026, a still larger amount of contact is occurring between the boss 1046 and the electrode node 1016. Presuming that this is maximum compression, a lowest resistance, Rlo, is created, which corresponds to maximum force being applied to the user input element 1007.

When force is detected, knowledge of the magnitude of force can be used in the delivery of haptic responses. For example, in one embodiment a predetermined resistance, e.g., R2, must be achieved prior to firing the motion generation devices or haptic components. Thus, light force touches, e.g., when a user's fingertips are resting on keys but not intentionally pressing down, and initial touches, e.g., at the beginning of a keystroke, will not activate a haptic component.

The amount of force can be used in other ways as well. Recall from FIG. 6 above that different waveforms (664) can be used to drive the motion generation or haptic devices. In one embodiment, the selection of which waveform to use can be a function of force. For example, a larger force may lead the control module to select a waveform delivering a more powerful haptic response, while a softer force leads to the selection of a waveform delivering a softer haptic response. The haptic response can be proportional to the force applied, inversely proportional to the force applied, or otherwise described as a function of the force applied.

FIG. 10 illustrates one other feature that can be incorporated into user input elements configured in accordance with embodiments of the invention regardless of whether they include conductive material so as to be operable with force sensing resistive devices, resistive membrane implementations, or membrane switch versions. In one or more embodiments, the user input element 1007 comprises a light pipe 1023 or other light conducting materials configured to transfer light from a light source 1024 received through a light conducting engagement layer 1022. The inclusion of a light pipe 1023 allows the user input element 1007 to serve as a key in a backlit keypad. Alternatively, the inclusion of a light pipe 1023 allows individual user input elements to be illuminated as they are pressed. As the boss 1046 with a lightpipe 1023 more strongly engages with the engagement layer 1022, more light is coupled from the engagement layer 1022 to the lightpipe 1023, and the brighter the backlighting of that particular key.

FIGS. 11 and 12 illustrate different coupling options for haptic devices 1128, 1228 to an engagement layer 1122, 1222. In FIG. 11, the haptic device 1128 has been mounted on an ell 1111 extending from the engagement layer 1122. By positioning the haptic device 1128 on the ell 1111, actuation of the haptic device 1128 applies a force to the ell 1111 along the z-axis 115. However, this force translates around the ell 1111 to deliver a multidimensional force to the user input element 1107 when it engages with the engagement layer 1122 (not shown).

In FIG. 12, the haptic device 1228 has been coupled to an orthogonal fin 1211 extending away from the engagement layer 1222. In this configuration, firing the haptic device 1228 applies a force to the fin 1211 along the x-axis 113. This causes the engagement layer 1222 to move along the x-axis 113 to deliver a haptic response to the user input element 1207 when it is engagement with the engagement layer 1122 (not shown).

The embodiments of FIGS. 11 and 12 are illustrative only. Numerous other configurations will be obvious to those of ordinary skill in the art having the benefit of this disclosure. For example, as noted above, haptic devices could be coupled to the engagement layer on different sides. One can be configured to impart a force along the x-axis, another along the y-axis, and another along the z-axis. The haptic devices can be fired in different combinations to deliver customized haptic sensations to an engaged user input element.

FIG. 13 illustrates a haptic user interface system 1300 that includes a haptic user interface 1301 configured in accordance with one or more embodiments of the invention operating in tandem with an electronic device 1302. As was the case with FIG. 1 above, the haptic user interface 1301 is disposed within a folio 1303, which serves as a housing for the haptic user interface 1301. The electronic device 1302 of this embodiment is arranged in a landscape orientation, which makes a first half 1331 of the folio 1303 substantially the same size as a second half 1332 of the folio 1303. Accordingly, the folio 1303 can be folded along a parting line like a book.

Rather than using a bus (104) to communicate with the electronic device 1302, the haptic user interface 1301 of FIG. 13 employs wireless communication 1333. The wireless communication 1333, which may be Bluetooth, IEEE 802.11, optical, infrared, or other communication, conveys electronic signals between the electronic device 1302 and the haptic user interface 1301.

A plurality of keys 1307, 1308, 1309, 1310, 1311, 1312 is disposed along the haptic user interface 1301. Each key 1307, 1308, 1309, 1310, 1311, 1312 is moveable along an axis to close a switch 1334. The switch 1334 can be a membrane switch as shown in FIG. 13, a force sensing switch as shown in FIG. 10, a resistive touch layer as shown in FIG. 3, or other type of switch.

A user applies a force 1362 to one or more of the keys 1307, 1308, 1309, 1310, 1311, 1312 by moving a key, e.g., key 1312, along the first axis. Movement of the key 1312 along the first axis closes the switch 1334. Disposed between the key 1312 and the switch 1334 is a mechanical layer 1322 that spans multiple keys 1307, 1308, 1309, 1310, 1311, 1312 along axes orthogonal to the first axis. One or more haptic devices, which are operable with and coupled to the mechanical layer 1322, are configured to impart a force upon the mechanical layer 1322 upon being fired by a control module to deliver a haptic response 1317 to the key 1312.

FIG. 14 shows the folio 1303 being closed. Initially, the first half 1331 is folded 1401 over the second half 1332 to form a book-like configuration 1402, and where the folio material substrate 1430 and lower layer 1435 of the haptic user interface are flexible, a user may press the backside 1405 of the folio to actuate one or more of the keys 1307, 1308, 1309, 1310, 1311, 1312 and receive a haptic response 1417. In effect, a user can press a pliable folio layer disposed opposite the engagement layer 1422 from the key 1312 to control the electronic device (1302). Graphic elements and/or indentions 1406 may be disposed along the backside 1405 of the folio material substrate 1430 to assist the user in knowing where to place a finger.

The embodiment of FIG. 14 can be useful when the electronic device 1302 is configured to be usable in a specific mode when the folio 1303 is closed. For example, when the folio 1303 is closed, a user may desire to use the electronic device 1302 as a music player. Thus, the graphic elements or indentions 1406 can be configured as a simplified key set, providing play, pause, forward, reverse, and volume controls. The user may thus control the music player without having to continually open and close the folio 1303. When the switch is closed, a haptic response 1417 occurs in accordance with the previous descriptions.

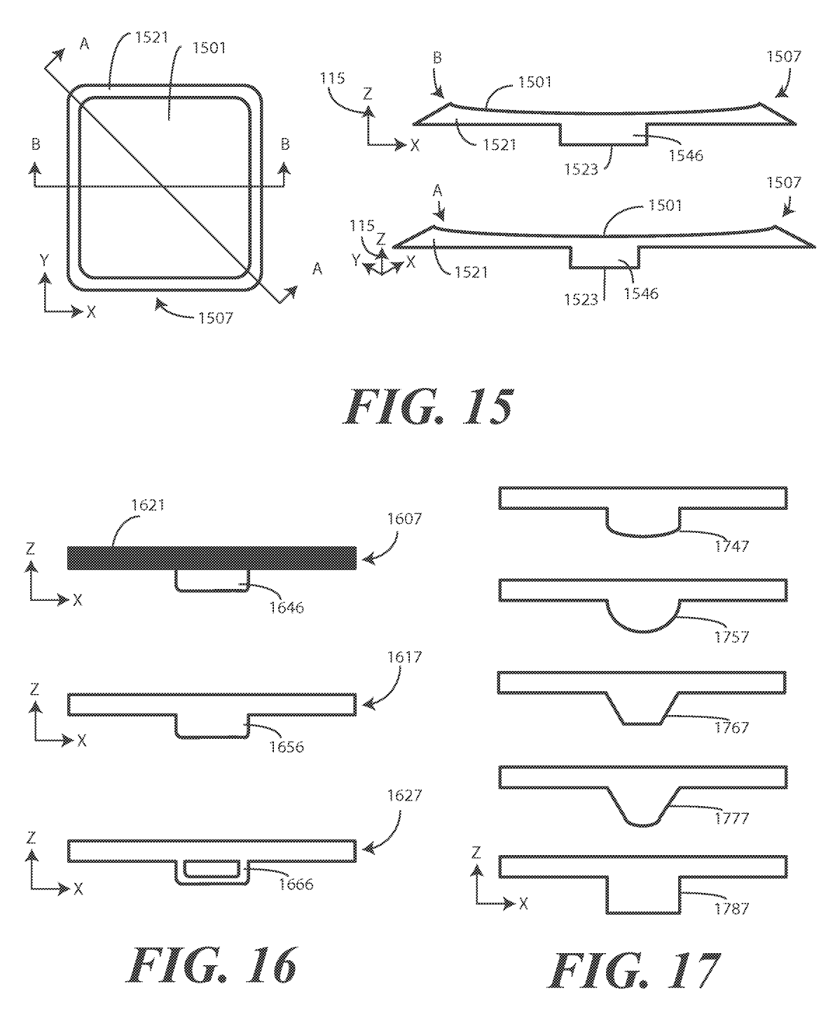

FIG. 15 illustrates one example of a user input element 1507 configured in accordance with one or more embodiments of the invention. The user input element 1507 is configured as a key and includes a user interaction surface 1521, a boss 1546, and a component interaction surface 1523. As shown, the user interaction surface 1521 includes a concave contour 1501 that guides a user's finger to a location above the boss 1546. The concave contour 1501 helps to direct forces applied to the user interaction surface 1521 along the z-axis 115, rather than laterally. This helps to ensure the boss 1546 passes through a corresponding aperture of a mechanical layer or engagement layer as described previously.

FIG. 16 illustrates alternative configurations of user interaction elements. User interaction element 1607 includes a rigid user interaction surface 1621 and a compliant, expandable boss 1646. User interaction element 1617 is made entirely of a compliant material to provide a soft-feeling user interaction experience. While user interaction element 1607 had a “hard” user interaction surface 1621, user interaction element 1617 includes a “softness” for additional comfort for a typist's fingers change in force. As noted above, the user interaction element 1617 may be manufactured from silicone or rubber. Note that the boss 1656 can be manufactured from the same material or a different material. For example, the boss 1656 may be manufactured from silicone or rubber, but may alternatively be manufactured from a different material such as felt.

Bosses can be made in other ways as well. User interaction element 1627 includes a hollow boss 1666 as one example. As noted above, the boss material can be conductive when the boss is to be used with a force sensing resistive switch. However, the boss material need not be conductive when a membrane switch or resistive touch panel is used.

FIG. 17 illustrates a variety of component interaction surfaces suitable for use with embodiments of the invention. The component interaction surfaces can be shaped and tailored to the specific switch with which it will be used. For example, a force sensing resistive switch may work more advantageously with a rounded component interaction surface, while a membrane switch may work well with a sharper contour that results in a reduced contact surface area.

Component interaction surface 1747 is configured as a convex contour. Such a contour is useful when using a force sensing resistive switch or resistive touch panel. This is one example of a non-linear contoured termination configuration. Component interaction surface 1757 is semi-spherical. Component interaction surface 1767 is frustoconical. Component interaction surface 1777 is frustoconical with a convex contour terminating the cone's frustum. This is another example of a non-linear contoured termination configuration. Component interaction surface 1787 is rectangular. These component interaction surfaces are illustrative only. Other shapes may be possible, as will be obvious to those of ordinary skill in the art having the benefit of this disclosure.

FIG. 18 illustrates a user interaction element 1807 having a plurality of bosses 1846, 1856, 1866, 1876. As noted above, in one or more embodiments multiple bosses 1846, 1856, 1866, 1876 can be used with a mechanical sheet or engagement layer that has a number of apertures corresponding to the number of bosses 1846, 1856, 1866, 1876. The number of bosses 1846, 1856, 1866, 1876 will vary with the application and design of the user interaction element 1807. Illustrating by example, when constructing a QWERTY keypad, a letter key, e.g., the “Q” key, may employ a single boss, while a larger key, e.g., the space bar, may have a plurality of bosses extending from its user interaction surface along its length. Multiple bosses extending from each user interaction element can be used for other applications as well, e.g., for providing short-cut functions when a user presses a corner or a side of a particular user interaction element.

FIG. 19 illustrates examples of boss configurations 1923, 1933, 1943, 1953 to show some of the variations suitable for use with embodiments of the invention. As shown the boss configurations 1923, 1933, 1943, 1953 can vary spatially across the width or length of each user interaction element 1907, 1917, 1927, 1937. They can also vary in number, location, component interaction surface, and so forth.

To this point, the interface peripherals described above have been primarily QWERTY keypads suitable for use with electronic devices, such as those having only touch sensitive surfaces and not having physical keys. However, as noted above, embodiments of the invention are not so limited. FIG. 20 illustrates just a few of the other types of keypads that can be configured with user interface elements, engagement layers, haptic devices, and switches to deliver a haptic response to a users. Still others will be obvious to those of ordinary skill in the art having the benefit of this disclosure. As shown in FIG. 20, the interface peripheral can be configured as any of a learning keypad 2001, a gaming keypad 2002, or a musical keypad 2003 to name a few.

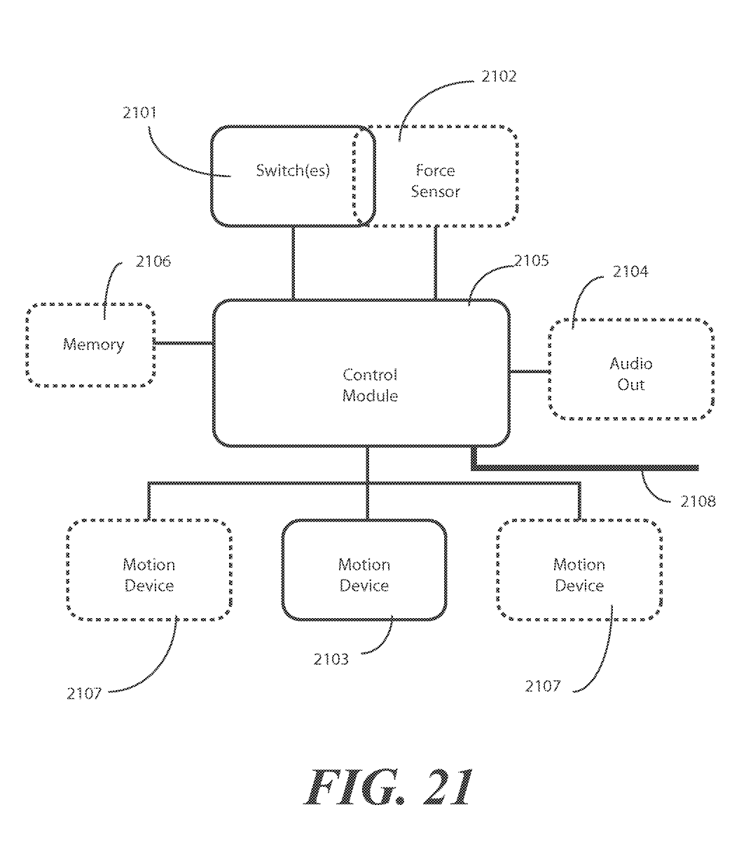

FIG. 21 illustrates a schematic block diagram of one embodiment of an interface peripheral configured in accordance with embodiments of the invention. A control module 2105 is configured to operate the various functions of the interface peripheral. The control module 2105 may be configured to execute software or firmware applications stored in an optional memory 2106. The control module 2105 can execute this software or firmware to provide interface peripheral functionality. A bus 2108 can be coupled to the control module 2105 for receiving information from sensors and detectors (not shown). The bus 2108 can optionally be used to provide access to power, memory, audio, or processing capabilities.

A plurality of switches 2101 is operable with the control module 2105 to detect user input. The switches 2101 are operable with corresponding user input elements to detect user actuation of one or more user actuation elements by closing when a user input element is translated along an axis. The switches 2101 can be membrane switches, a resistive touch panel, or resistive force sensing switches 2102. Where membrane switches are employed, the control module can detect actuation of a user input element by detecting one or more of the membrane switches closing.

Where a resistive touch panel or resistive force sensing switches 2102 are employed, a plurality of electrode nodes can be coupled to, and is operable with, the control module 2105. In one embodiment, the control module 2105 can be configured to sense either current or voltage through each electrode node. The amount of current or voltage will depend upon the surface area of each compressible (optionally conductive, depending on implementation) boss when actuated by a user, as the surface area defines a corresponding resistance across each electrode node. The control module 2105 detects this current or voltage across each electrode node and correlates it as an applied force.

When a switch actuates, the control module 2105 can fire a motion generation component 2103. Where additional motion generation components 2107 are included, the control module 2105 can fire them in combination, or separately. In one or more embodiments, an audio output 2104 can be configured to deliver an audible “click” or other suitable sound in conjunction with the haptic feedback.

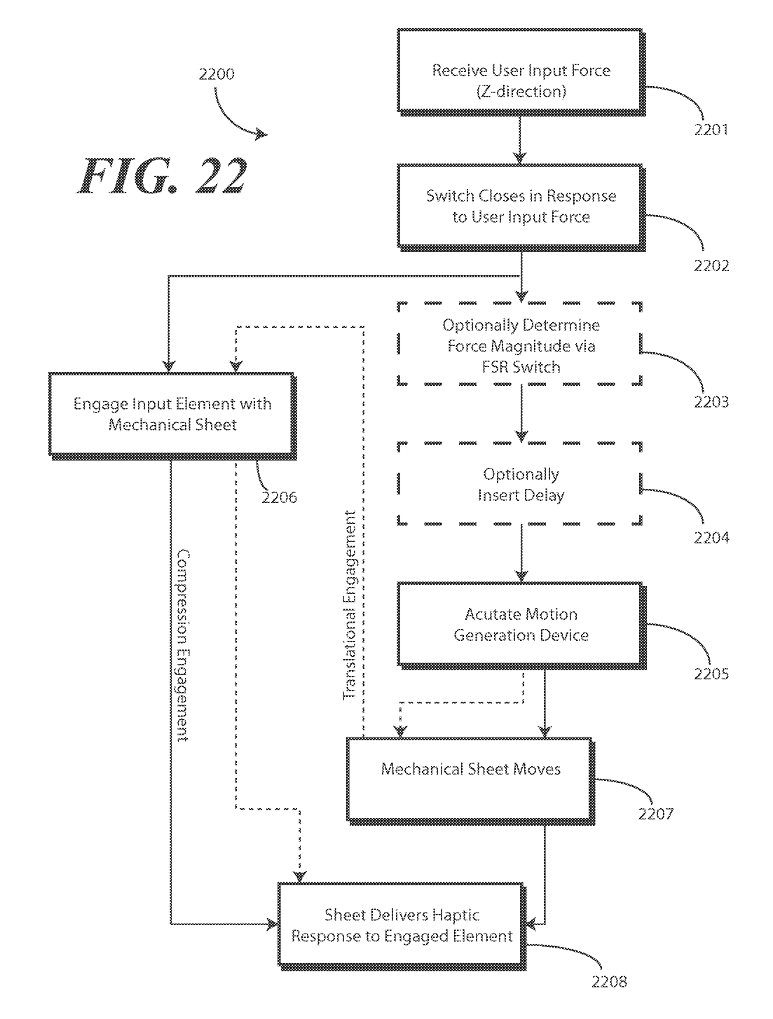

FIG. 22 illustrates a method 2200 of delivering haptic feedback in accordance with one or more embodiments of the invention. The steps of the method 2200 have largely been described above with reference to various hardware components and control modules that perform the various steps. Accordingly, the steps will only briefly be described here.

At step 2201, user input resulting from translation of a user input element is received. In one embodiment, the user input is received by detecting a switch closing at step 2202 when a user input element is translated along the z-axis (115) in response to the application of force on a user interaction surface of the user interaction element. In another embodiment, the user input is received by detecting a user press along a pliable (folio layer) substrate disposed opposite a mechanical sheet or engagement layer from a plurality of keys.

At optional step 2203, a magnitude of the applied force can optionally be determined by using a force sensing element or resistive touch layer. At step 2204, an optional delay of a predetermined time can be inserted.

Steps 2205 and 2206 can occur in either order. At step 2205, a motion generation component coupled to the mechanical sheet or engagement layer is actuated. In one embodiment, the mechanical sheet or engagement layer actuated is one of a plurality of sheets. In such an embodiment, step 2205 can also include determining which of the plurality of sheets corresponds to the user input element actuated at step 2201 and actuating only the motion generation component corresponding to a single actuated key or multiple actuated keys.

At step 2206, the user input element to which the force of step 2201 was applied engages with the mechanical sheet or engagement layer. As described above, the engagement can be translational engagement or compression engagement. Compression engagement can include grasping, with only a single key, the mechanical sheet or engagement layer.

After step 2205 has occurred, the mechanical sheet or engagement layer moves at step 2207. When both steps 2205, 2206 have occurred, regardless of order, the mechanical sheet or engagement layer delivers a haptic response to an engaged user input element at step 2208. In one embodiment, this haptic response is delivered to a single key by moving the mechanical sheet when engaged with the single key. In another embodiment, the haptic response can be delivered to a combination of keys actuated by the user.

It should be observed that the embodiments described above reside primarily in combinations of method steps and apparatus components related to haptic feedback delivery by moving a mechanical sheet or engagement layer that spans a plurality of keys, is capable of engaging any of the plurality of keys, but engages only those actuated by a user. Any process descriptions or blocks in flow charts should be understood as representing modules, segments, or portions of code that include one or more executable instructions for implementing specific logical functions or steps in the process. Alternate implementations are included, and it will be clear that functions may be executed out of order from that shown or discussed, including substantially concurrently or in reverse order, depending on the functionality involved. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

It will be appreciated that embodiments of the invention described herein may be comprised of one or more conventional processors and unique stored program instructions that control the one or more processors to implement, in conjunction with certain non-processor circuits, some, most, or all of the functions of the control module described herein. As such, these functions may be interpreted as steps of a method to perform haptic feedback delivery. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions. Also, reference designators shown herein in parenthesis indicate components shown in a figure other than the one in discussion. For example, talking about a device (10) while discussing figure A would refer to an element, 10, shown in a figure other than figure A.

In the foregoing specification, specific embodiments of the present invention have been described. However, one of ordinary skill in the art appreciates that various modifications and changes can be made without departing from the scope of the present invention as set forth in the claims below. Thus, while preferred embodiments of the invention have been illustrated and described, it is clear that the invention is not so limited. Numerous modifications, changes, variations, substitutions, and equivalents will occur to those skilled in the art without departing from the spirit and scope of the present invention as defined by the following claims. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims.

What is claimed is:

1. An interface peripheral, comprising:
a plurality of keys;
an engagement layer spanning two or more of the plurality of keys; and
a motion generation component coupled to the engagement layer;
wherein:
the engagement layer defines two or more apertures corresponding to the two or more of the plurality of keys; and
the engagement layer is configured to mechanically engage at least one key of the two or more of the plurality of keys and deliver a haptic response to the at least one key when the motion generation component actuates.

2. The interface peripheral of claim 1, wherein the engagement layer is configured to mechanically engage a boss of the at least one key after the boss enters an aperture defined in the engagement layer.

3. The interface peripheral of claim 2, wherein each of the two or more of the plurality of keys comprises a corresponding user interaction surface and a corresponding boss extending distally away from the corresponding user interaction surface, the corresponding boss terminating in a component interaction surface.

4. The interface peripheral of claim 2, wherein:
the two or more apertures are each rectangular in shape; and
the boss has a round cross section.

5. The interface peripheral of claim 2, wherein the boss comprises a non-linear contoured termination.

6. The interface peripheral of claim 2, wherein the two or more of the plurality of keys and the engagement layer each comprises a light guide.

7. The interface peripheral of claim 2, wherein the corresponding boss is manufactured from a pliant material.

8. The interface peripheral of claim 2, wherein:
a width of the aperture is greater than a diameter of the boss; and
the boss is configured to expand upon actuation to contact at least part of a perimeter of the aperture.

9. The interface peripheral of claim 1, wherein the motion generation component comprises one of a piezoelectric transducer, a vibrator motor, a rotator motor, an artificial muscle, an electrostatic plate, or combinations thereof.

10. A method of delivering haptic feedback, comprising:
receiving a force applied to a single key that causes the single key to grasp a sheet configured for selective engagement with each key of a plurality of keys; and
in response to user input detected by a closing switch actuating a motion generation component coupled to the sheet to deliver a haptic response to the single key by moving the sheet when engaged with the single key.

11. The method of claim 10, further comprising:
delaying the actuating for a predetermined time after the user input.

12. The method of claim 10, further comprising:
determining an amount of the force with which the single key is actuated; and
controlling the motion generation component based on the amount of the force.

13. The method of claim 10, wherein the force causes a boss of the single key to pass through an aperture defined in the sheet, and further to expand to engage at least a portion of a side of the aperture.

14. The method of claim 10, wherein the sheet is one of a plurality of sheets, further comprising:
determining which of the plurality of sheets corresponds to the single key, wherein the actuating comprises actuating only the motion generation component coupled to the sheet corresponding to the single key.

15. The method of claim 10, wherein the receiving the force comprises:
receiving the force from a substrate disposed opposite the sheet from the plurality of keys.

16. The method of claim 10, wherein the providing the force comprises:
receiving a user press along a pliable folio layer disposed opposite the sheet from the plurality of keys, wherein the actuating the motion generation component further delivers haptic feedback to the pliable folio layer

17. A haptic user interface system, operable with an electronic device, the haptic user interface system comprising:
a plurality of user input elements, each being moveable along a first axis to close a switch;
a mechanical layer spanning the plurality of user input elements along a second axis and a third axis, the second axis and the third axis being orthogonal with the first axis, the mechanical layer defining a plurality of apertures corresponding to the plurality of user input elements on a one-to-one basis; and
one or more haptic devices, operable to impart force upon the mechanical layer;
wherein movement of a user input element along the first axis engages at least part of a perimeter of an aperture of the mechanical layer; and
actuation of the one or more haptic devices delivers a haptic response to the user input element when engaged with the mechanical layer.

18. The haptic user interface system of claim 17, wherein the one or more haptic devices comprise:
a first haptic device oriented to impart a first axis force upon the mechanical layer along the second axis;
a second haptic device oriented to impart a second axis force along the third axis; or
a combination thereof.

19. The haptic user interface system of claim 18, further comprising:
a control module configured to selectively actuate one of:
the first haptic device in response to the switch closing;
the second haptic device in response to the switch closing; or
combinations thereof.

20. The haptic user interface system of claim 17, further comprising:
a substrate disposed on an opposite side of the mechanical layer from the plurality of user input elements; and
an array of force sensing resistive switches disposed between the substrate and the mechanical layer, with each force sensing resistive switch being associated with a corresponding user input element, wherein the each force sensing resistive switch is configured to determine a force magnitude applied to the user input element by detecting an engagement surface area between a boss extending from the user input element and a corresponding force sensing resistive switch.
